(19) United States
(12) Patent Application Publication
(10) Pub. No.: US 2025/0380649 A1
(43) Pub. Date: Dec. 18, 2025

(54) METHOD FOR RAISING RICE SEEDLINGS IN BLOCK MATRIX COTTON BASED ON WALNUT GREEN PEEL FERMENTATION EXTRACT

(71) Applicant: China National Rice Research Institute, Hangzhou City (CN)

(72) Inventors: Yikai ZHANG, Hangzhou City (CN); Huizhe CHEN, Hangzhou City (CN); Yuping ZHANG, Hangzhou City (CN); Jing XIANG, Hangzhou City (CN); Yaliang WANG, Hangzhou City (CN); Yicheng XU, Hangzhou City (CN); Zhigang WANG, Hangzhou City (CN); Xuexian CAO, Hangzhou City (CN)

(73) Assignee: China National Rice Research Institute, Hangzhou City (CN)

(21) Appl. No.: 18/818,026

(22) Filed: Aug. 28, 2024

(30) Foreign Application Priority Data
Jun. 17, 2024 (CN) 2024107762207

(51) Int. Cl. A01G 24/22; A01G 22/22; C05G 3/60

(52) U.S. Cl. CPC A01G 24/22; A01G 22/22; C05G 3/60

(57) ABSTRACT

The disclosure belongs to the technical field of rice planting and discloses a method for raising rice seedlings in block matrix cotton based on a walnut green peel fermentation extract. The walnut green peel fermentation extract of the disclosure is obtained by crushing and fermenting the walnut green peel, decomposing it in an alkaline environment, and extracting a water-soluble extract and an organic solvent extract, respectively. The obtained walnut green peel fermentation extract can improve the effect in soaking seeds of rice, adjust an acidity of the matrix cotton, and synergistically improve prevention and control of seed-borne diseases such as bakanae disease; and the walnut green peel fermentation extract is used to replace chemical control agents in block matrix cotton seedling raising to promote strong seedlings and root growth, which facilitates machine transplantation and improves machine transplantation efficiency.

### CROSS-REFERENCE TO RELATED APPLICATIONS

This application claims the benefit of priority from China Patent Application No. 2024107762207 filed on Jun. 17, 2024, the contents of which are hereby incorporated by reference in their entirety.

### TECHNICAL FIELD

The disclosure belongs to the technical field of rice planting, and in particular, to a use of a walnut green peel fermentation extract in raising rice seedlings in block matrix cotton.

### BACKGROUND

The rice planting area in China is about 450 million mu. With the large-scale promotion of machine transplantation technology, the machine transplantation rate has exceeded 40%. The annual use of plastic seedling trays is about 3 billion, and the consumption of nutrient soil is nearly 300 million m³. In order to solve the problems of difficulty in collection of nutrient soil, vegetation destruction, high costs of materials for seedling trays, and to alleviate current shortage of rural labor force, many scientific research institutions and enterprises have developed a series of rice seedling matrix cotton blocks that replace nutrient soil and seedling trays.

The seedling-raising matrix cotton currently commonly used in rice production is an inorganic short fiber block matrix prepared from basalt minerals, aluminum silicate minerals, etc. as main raw materials by high-temperature melting, spraying and other processes. This type of matrix products plays an important role in quality, root growth, water and fertilizer retention of rice seedlings and reduction of labor intensity, and promotes mechanized rice production. However, during the process of rice production application, we found that compared with conventional bulk nutrient soil, the use of block matrix for raising seedlings is more likely to cause bakanae disease, which poses hidden dangers to the safety of rice production. In addition, although the seedling-raising matrix cotton has been solidified into blocks, it contains some minerals, and thus there are still problems with poor root growth and weak growth of above-ground seedlings, leading to poor quality of machine transplanting operations and slow greening of seedlings.

### SUMMARY

In view of this, the disclosure provides a use of a walnut green peel fermentation extract in raising rice seedlings in block matrix cotton from the aspects of controlling the occurrence of bakanae disease in seedlings, promoting root elongation, and facilitating mechanical transplantation of seedlings.

The technical solution of the disclosure is as follows:

A method for preparing the walnut green peel fermentation extract includes the following steps: crushing walnut green peel and mixing the crushed walnut green peel with a nitrogen fertilizer for compost fermentation to obtain a fermentation product, soaking the fermentation product in water and adjusting a pH to alkaline for reaction, and performing solid-liquid separation after the reaction is completed to obtain solid materials and liquid materials; neutralizing the pH of the liquid materials to acidity, and freeze-drying to obtain a liquid extract; and extracting the solid materials with an organic solvent to obtain a solid extract. The liquid extract and the solid extract are mixed to obtain the walnut green peel fermentation extract.

Preferably, the nitrogen fertilizer is an inorganic nitrogen fertilizer and an organic nitrogen fertilizer, and a ratio of pure nitrogen therebetween is 8-10:1-2.

Preferably, sodium hydroxide is used to adjust the pH to 10-12, and sulfuric acid or acetic acid is used to neutralize the pH of the liquid materials to 3-4.

The disclosure provides a use of the above-mentioned walnut green peel fermentation extract in any one of:
A. seed treatment or preparation of a product for seed treatment;
B. rice seedling raising or preparation of matrix for rice seedling raising;
C. preparation of a product for controlling bakanae disease; and
D. preparation of a product that promotes strong seedlings and root growth.

The disclosure provides a seed treatment agent, which includes a diluent of the walnut green peel fermentation extract and a seed disinfectant.

The disclosure provides a seedling-raising matrix cotton, into which the walnut green peel fermentation extract is added.

Preferably, the seedling-raising matrix cotton further comprises a fertilizer. Further preferably, the fertilizer is any one or more of large, medium trace element fertilizers, and a weight ratio of the walnut green peel fermentation extract to the fertilizer is 1-2:12-20.

The disclosure further provides a method for preparing the seedling-raising matrix cotton, including formulating the walnut green peel fermentation with NPK and compound medium and trace element fertilizers into a mother liquor, diluting the mother liquor and then spraying the diluted mother liquor evenly on a surface of the seedling-raising matrix cotton, and drying the sprayed surface of the seedling-raising matrix cotton.

The disclosure provides a method for raising rice seedlings in the seedling-raising matrix cotton, which includes the following steps: soaking rice seeds with a diluent of the walnut green peel fermentation extract and the seed disinfectant to accelerate germination, fully irrigating the seedling-raising matrix cotton with water to be sown and covered with soil; spraying the walnut green peel fermentation extract on the seedlings with one leaf and one center at an application rate of 800 to 2,000 g per mu.

As an embodiment, if a temperature exceeds 30° C. and the rice seedlings and roots grow too fast, or the seedlings suffer from drought stress, or the seedlings lack the fertilizer and bakanae disease occurs, the walnut green peel fermentation extract is mixed with ammonia nitrogen fertilizer to prepare a liquid spray for spraying, where the walnut green peel fermentation extract is applied at 1,000 to 1,500 g per mu.

Compared with the prior art, the disclosure has the following technical effects:

In the disclosure, the walnut green peel is fermented and extracted to obtain a natural plant fermentation extract. The walnut green peel fermentation extract of the disclosure can improve effects in soaking seeds of rice, adjust the pH of the matrix cotton, and synergistically improve the prevention and control of seed-borne diseases such as bakanae disease.

In view of problems such as root growth and seedling delicacy in the process of growing seedlings in matrix cotton, the disclosure uses the walnut green peel fermentation extract to regulate the growth of the above-ground part of the seedlings, stimulate the elongation of the rice seed roots, promote the thickening of the root system, facilitate machine transplantation, and improve machine transplantation efficiency.

### DETAILED DESCRIPTION OF EMBODIMENTS

The disclosure provides a walnut green peel fermentation extract, which is prepared by the following method including: crushing walnut green peel and mixing the crushed green peel with a nitrogen fertilizer for compost fermentation to obtain a fermentation product, soaking the fermentation product in water and adjusting a pH to alkaline for reaction, and performing solid-liquid separation after the reaction is completed to obtain solid materials and liquid materials; neutralizing the pH of the liquid materials to acidity, and freeze-drying to obtain a liquid extract; and extracting the solid materials with an organic solvent to obtain a solid extract. The liquid extract and the solid extract are mixed to obtain the walnut green peel fermentation extract.

In the disclosure, the walnut green peel is crushed and sieved through a 5 to 10 mm sieve to maintain good ventilation and decomposition state, which is conducive to the full decomposition of the walnut green peel during the high-temperature compost fermentation process.

In the disclosure, the nitrogen fertilizer is an inorganic nitrogen fertilizer and an organic nitrogen fertilizer. The addition of the nitrogen fertilizer is conducive to generating sufficient heat, promoting the fermentation process, and increasing acid-generating substances. Preferably, a ratio of pure nitrogen in the inorganic nitrogen fertilizer and the organic nitrogen fertilizer is 8-10:1-2, and further preferably 10:1.

The high-temperature compost fermentation of the disclosure can be carried out in a conventional manner. The high-temperature compost fermentation is preferred for 40 to 60 days. After full fermentation, the fermentation material is cooled down. When the temperature drops below 35° C., the fermentation material is dried, crushed, and sieved through a 0.2 to 0.5 mm sieve to obtain a fermentation product.

The fermentation product of the disclosure is soaked in water, and the pH is adjusted to alkaline to decompose organic materials. It is preferably adjusted with sodium hydroxide, and further, the sodium hydroxide has a concentration of 1M. It is preferable to adjust the pH to 10-12 to accelerate the decomposition speed and degree. After the decomposition reaction is completed, solid-liquid separation is performed to obtain solid materials and liquid materials.

The solid materials of the disclosure are extracted with an organic solvent. Optional organic solvents include petroleum ether and ethyl acetate. Preferably, the organic solvent is a 60% to 80% organic solvent solution. After extraction, the solid materials are dried by rotary evaporation to obtain a solid extract.

The liquid materials of the disclosure are neutralized to acidity and freeze-dried to obtain a liquid extract. It is preferred to neutralize the liquid extract with 1 to 2M acetic acid or sulfuric acid, and preferably, the pH of the liquid extract is neutralized to 3-4.

The walnut green peel fermentation extract of the disclosure is a mixture of the liquid extract and the solid extract. Preferably, a mass ratio of the liquid extract to the solid extract is 0.4-0.7:1, further preferably 0.5:1.

The walnut green peel fermentation extract of the disclosure has the functions of controlling bakanae disease, promoting the elongation and growth of rice root system, and regulating the pH of the matrix cotton. Therefore, the walnut green peel fermentation extract can be used to prepare products for controlling bakanae disease and in the process of rice seed soaking and seedling raising.

The disclosure provides a seed treatment agent, which includes a diluent of the walnut green peel fermentation extract of the disclosure and a seed disinfectant. The fermented walnut green peel extract of the disclosure is diluted 800 to 1,500 times, and other conventional disinfectants are added to soak the rice seeds. The conventional disinfectants include prochloraz, phenamacril, etc. The seeds are soaked at a temperature of preferably 25 to 32° C. for preferably 2 to 3 days, and the seeds are sown after germination. The walnut green peel fermentation extract can improve effects in soaking seeds of rice and synergistically improve the prevention and control of seed-borne diseases such as bakanae disease.

The disclosure provides a seedling-raising matrix cotton, which comprises the walnut green bark fermentation extract. Preferably, the seedling-raising matrix cotton further comprises a fertilizer, and the fertilizer is any one or more of large, medium trace element fertilizers. A weight ratio of the fertilizer to the walnut green peel fermentation extract is 1-2:12-20. The proportion of ammonium nitrogen in the seedling-raising matrix cotton fertilizer is increased, where the conventional ammonium to nitrate ratio is increased from 1:1 to 2:0. Other fertilizers include fast-acting phosphate fertilizers and potassium fertilizers, and cooperate with the walnut green bark fermentation extract to control the growth of the above-ground part of the seedlings, and promote rice root elongation and growth. The disclosure does not specifically limit the type of the seedling-raising matrix cotton, and the existing known block matrix can be used, such as block rock wool. The thickness of the conventional block matrix is 13-18 mm, the length of a 9-inch block matrix for seedlings is 580 mm×280 mm, and the length of a 7-inch block matrix for seedlings is 580 mm×228 mm.

The disclosure provides a method for preparing the above-mentioned seedling-raising matrix cotton, including formulating the walnut green peel fermentation extract with NPK and compound medium trace element fertilizers into a mother liquor, diluting the mother liquor and spraying the diluted mother liquor evenly on the surface of the seedling-raising matrix cotton, and drying the sprayed seedling-raising matrix cotton. Taking the 9-inch block matrix cotton for seedling raising as an example, each seedling block has a volume of 2.1 to 3.0 dm³, and applied with 0.5 to 1.0 g of the walnut green peel fermentation extract. In the disclosure, a preferred mass ratio of the walnut green peel fermentation extract to NPK and compound medium trace element fertilizers is 5-10:90-95. The preferred dilution factor of the mother liquor in the disclosure is 50-100 times. The drying method is not particularly limited in the disclosure, and it is preferable to use hot steam drying to form a co-crystal of a mixture of the fertilizers and the walnut green peel fermentation extract. The viscosity of the walnut green peel fermentation extract is used to fully mix with the fertilizers to prevent the fertilizers loss during storage and transportation; in addition, when the walnut green peel fermentation extract is combined with the block matrix during seedling raising, upper nutrients are chelated with organic materials and slowly released, reducing the impact on the germination of rice seeds and improving the germination of weak seeds; moreover, a lower matrix block serves to store nutrients, reduce nutrient loss, reduce the workload of fertilizer supplementation in the later period, and help the seedlings form strong seedlings.

The disclosure provides a method for raising rice seedlings in the seedling-raising matrix cotton, which includes the following steps: soaking rice seeds with the seed treatment agent to accelerate germination, fully irrigating the seedling-raising matrix cotton with water to be sown and covered with soil; and spraying the walnut green peel fermentation extract on the seedlings with one leaf and one center at an application rate of 800 to 2,000 g per mu.

The seed soaking and germination method of the rice seeds of the disclosure is as described above and will not be described again.

The seedling-raising matrix cotton of the disclosure is fully irrigated with water, and each 9-inch seedling block is irrigated with water in an amount of about 1,500 to 2,000 mL, which is larger than the first water consumption of the traditional matrix. The covering soil needs to be a granular matrix or nutrient soil with a specific gravity at a suitable density of 1.0-1.5 g/cm³ to prevent floating seedlings during flooding.

In the disclosure, during seedling raising, the walnut green peel fermentation extract is sprayed on the seedlings with one leaf and one core in an application amount of 800 to 2,000 g/mu, and further preferably 1,200 to 1,800 g/mu. 50 to 100 mL of medicinal solution per 9-inch tray are applied to prevent the occurrence of bakanae disease. If the temperature is higher than 30° C. and the rice seedlings and roots grow too fast, or the seedlings suffer from drought stress, or the seedlings are short of fertilizers and suffer from bakanae disease, the walnut green peel fermentation extract is mixed with ammonia nitrogen fertilizer to prepare a liquid spray. The mass ratio is preferably 1:3-6, and further preferably 1:4. The walnut green peel fermentation extract is applied in an amount of 1,000 to 1,500 g per mu, and further preferably 1,200 to 1,300 g per mu.

The technical solution of the disclosure will be introduced in further detail below with reference to specific embodiments. The technical solution of the disclosure includes but is not limited to the following examples.

### Example 1

### Preparation of the Walnut Green Peel Fermentation Extract

After the walnut green peel was harvested, it was crushed directly and sieved through a 5 to 10 mm sieve, and then mixed with an inorganic nitrogen fertilizer and an organic nitrogen fertilizer in a ratio of pure nitrogen of 10:1. After 40 days of high-temperature compost fermentation, the temperature dropped to below 35° C., and the fermented walnut green peel was dried, crushed and sieved through a 0.2 to 0.5 mm sieve. In the first step, after soaking in distilled water, 1M sodium hydroxide was added to adjust the pH to 12. After the solid-liquid separation was completed, 1M sulfuric acid was added to the liquid to adjust the pH to 4, and freeze-dried to separate the water-soluble extract; after the remaining solid materials were extracted with 60% to 80% organic solvent ethyl acetate, they were dried by rotary evaporation to separate the organic solvent extract. After mixing the two extracts at a weight ratio of 0.5:1, the walnut green peel fermentation extract was formed.

### Example 2

### Preparation of the Walnut Green Peel Fermentation Extract

After the walnut green peel was harvested, it was crushed directly, and sieved through a 5 to 10 mm sieve, and then mixed with an inorganic nitrogen fertilizer and an organic nitrogen fertilizer in a ratio of pure nitrogen of 10:1. After 60 days of high-temperature compost fermentation, the temperature dropped to below 35° C., and the fermented walnut green peel was dried, crushed and sieved through a 0.2 to 0.5 mm sieve. In the first step, after soaking in distilled water, 1M sodium hydroxide was added to adjust the pH to 11. After the solid-liquid separation was completed, 2M acetic acid was added to the liquid to adjust the pH to 3, and freeze-dried to separate the water-soluble extract; after the remaining solid materials were extracted with 60% to 80% petroleum ether, they were dried by rotary evaporation to separate the organic solvent extracts. After mixing the two extracts at a weight ratio of 0.7:1, the walnut green peel fermentation extract was formed.

### Example 3

A seed treatment agent containing an 800-fold diluent of the walnut green peel fermentation extract prepared in Example 1 and a 1,500-fold diluent of prochloraz.

### Example 4

A seed treatment agent containing a 1,500-fold diluent of the walnut green peel fermentation extract prepared in Example 2 and a 1,500-fold diluent of phenamacril.

### Example 5

### Preparation of the Seedling-Raising Matrix Cotton

After laying out a 9-inch block matrix cotton, the walnut green peel fermentation extract in Example 1, NPK, and compound medium trace element fertilizers were prepared into a mother liquor in a ratio of 10:82:8 (w/w). The mother liquor was diluted 50 times and sprayed evenly on the surface of the block matrix cotton, and the sprayed block matrix cotton was further dried with hot steam to form a block seedling-raising matrix of co-crystals of the fertilizer and the extraction mixture. 1.0 g of the walnut green peel fermentation extract was applied to each seedling block (a volume of 2.1 to 3.0 dm³).

### Example 6

### Preparation of Seedling-Raising Matrix Cotton

After laying out a 9-inch block matrix cotton, the walnut green peel fermentation extract in Example 2, NPK, and compound medium trace element fertilizers were prepared into a mother liquor in a ratio of 10:86:4 (w/w). The mother liquor was diluted 50 times and sprayed evenly on the surface of the block matrix cotton, and the sprayed block matrix cotton was further dried with hot steam to form a block seedling-raising matrix of co-crystals of the fertilizer and the extraction mixture. 0.5 g of the walnut green peel fermentation extract was applied to each seedling block (a volume of 2.1 to 3.0 dm³).

### Example 7

### Seedling Raising of Rice Varieties Highly Susceptible to Bakanae Disease

In Fuyang base of the China Rice Research Institute, a comparative test was carried out on seedling raising in matrix cotton, where the early rice variety Zhongzao 39, being an indica conventional rice and susceptible to bakanae disease, was selected. The test started on March 20 with a seeding rate of 100 grams/tray (dry grain), the concentration of the materials selected for seed soaking was 1,500 times of the walnut green peel fermentation extract and 1,500 times of the conventional seed soaking agent prochloraz. The seeds were soaked for 48 hours. The soaked seeds were cleaned and sown at 32° C. after germination overnight. The application amount of the walnut green peel fermentation extract for each tray of 9-inch early rice seedling-raising matrix cotton block was 1.0 g. The walnut green peel fermentation extract, NPK compound fertilizers, and medium trace element fertilizers were prepared into a mother liquor in a ratio of 10:84:6, and the mother liquor was diluted 50 times, and sprayed evenly on the surface of the block cotton seedling-raising matrix by spraying or other methods, and the sprayed block cotton was further steam-dried to form a block matrix suitable for early rice seedling raising. Early rice was sown in the block seedling-raising matrix cotton and then placed in a facility to raise seedlings. When the seedlings were in one leaf and one center, the walnut green peel fermentation extract was sprayed thereon at an application amount of 2,000 g/mu and 50 to 100 mL of liquid per plate, to prevent the occurrence of bakanae disease. If bakanae disease occurred in the later stage, the application amount of the walnut green peel fermentation extract was 1,500 g/mu, and the fermentation extract powder and the ammonia nitrogen fertilizer were mixed into a liquid spray at a ratio of 1:4. After 30 days of seedling raising, the occurrence of bakanae disease and the quality of the seedlings treated were investigated, such as the incidence of bakanae disease, biomass, root entanglement force, root diameter, and seedling formation rate.

It was observed that with the growth of rice seedlings highly infected with bakanae disease, the growth of rice seedlings treated with walnut shell extract was significantly higher than that of control seedlings (Table 1), and the disease was significantly reduced. In addition, the plant height of rice seedlings treated with the walnut shell extract was appropriately reduced, the root entanglement force was increased, and the root diameter was significantly increased, without affecting the measured seedling rate of rice seedlings.

TABLE 1
Effects of seedling-raising matrix cotton on the occurrence
of rice bakanae disease and seedling growth

| | | incidence | | | | | |
|---|---|---|---|---|---|---|---|
| | stem | of | biomass | | root | root | |
| | height | bakanae | (g/100 | leaf | entanglement | diameter | seedling |
| treatment | (cm) | disease | plants) | age | force (kg) | (mm) | rate % |
| blank block | 18a | 43%a | 1.43b | 3.1a | 4.04b | 0.363a | 94.6a |
| matrix control | | | | | | | |
| treatment of | 16b | 0.21%b | 1.89a | 3.3a | 4.29a | 0.335b | 95.7a |
| block seedling- | | | | | | | |
| raising matrix | | | | | | | |
| cotton of the | | | | | | | |
| disclosure | | | | | | | |

### Example 8

Seedling Raising of Rice Varieties with Medium and Low Susceptibility to Bakanae Disease

In Fuyang base of the China Rice Research Institute, a comparative test was carried out on seedling raising in matrix cotton, where the rice variety Zhehexiang No. 2, being a japonica conventional rice with medium to low susceptibility to bakanae disease, was selected. The test started on May 20 with a seeding rate of 100 grams/tray (dry grain), the concentration of the materials selected for seed soaking was 800 times of the walnut green peel fermentation extract and 1,500 times of the conventional seed soaking agent prochloraz. The seeds were soaked for 48 hours. The soaked seeds were cleaned and sown at 30° C. after germination overnight. The application amount of the walnut green peel fermentation extract for each tray of 9-inch early rice seedling-raising matrix cotton block was 0.5 g. The walnut green peel fermentation extract, NPK compound fertilizers, and medium trace element fertilizers were prepared into a mother liquor in a ratio of 5:88:7, and the mother liquor was diluted 50 times, and sprayed evenly on the surface of the block matrix by spraying or other methods, and the sprayed block matrix was further steam-dried to form a block matrix suitable for early rice seedling raising. Early rice was sown in the block matrix and then placed in a facility to raise seedlings. When the seedlings were in one leaf and one center, the walnut green peel fermentation extract was sprayed thereon at an application amount of 800 g/mu and 50 to 100 mL of liquid per plate, to prevent the occurrence of bakanae disease. If bakanae disease occurred in the later stage, the application amount of the walnut green peel fermentation extract was 1,000 g/mu, and the fermentation extract powder and the ammonia nitrogen fertilizer were mixed into a liquid spray at a ratio of 1:6. After 30 days of seedling raising, the occurrence of bakanae disease and the quality of the seedlings treated were investigated, such as the incidence of bakanae disease, biomass, root entanglement force, root diameter, and seedling formation rate.

It was observed that with the growth of rice seedlings with low to medium infection of bakanae disease, the growth of rice seedlings treated with the walnut shell extract was significantly higher than that of control seedlings (Table 2), and the occurrence of disease was significantly reduced. In addition, the plant height of rice seedlings treated with the walnut shell extract was reduced, the root entanglement force was increased, and the root diameter was significantly increased, which was beneficial to mechanical transplantation of rice seedlings in the field, without affecting the measured seedling rate of rice seedlings.

TABLE 2
Effects of seedling-raising matrix cotton on the occurrence
of rice bakanae disease and seedling growth

| | | incidence | | | | | |
|---|---|---|---|---|---|---|---|
| | height | of | biomass | | root | root | |
| | length | bakanae | (g/100 | leaf | entanglement | diameter | seedling |
| treatment | (cm) | disease | plants) | age | force (kg) | (mm) | rate % |
| blank block | 19a | 39%a | 1.77b | 3.5a | 5.67a | 0.371a | 95.5a |
| matrix control | | | | | | | |
| treatment of | 17b | 0%b | 2.05a | 3.6a | 5.89b | 0.349b | 96.1a |
| block seedling- | | | | | | | |
| raising matrix | | | | | | | |
| cotton of the | | | | | | | |
| disclose | | | | | | | |

The above are only the preferred embodiments of the disclosure. It should be pointed out that those skilled in the art can also make several improvements and modifications without departing from the principles of the disclosure. These improvements and modifications should also be regarded as the protection scope of the disclosure.

What is claimed is:

1. A use of a walnut green peel fermentation extract in any one of:
A. seed treatment or preparation of a product for seed treatment;
B. rice seedling raising or preparation of a matrix for rice seedling raising;
C. preparation of a product for controlling bakanae disease; and
D. preparation of a product that promotes strong seedlings and root growth;
wherein a method for preparing the walnut green peel fermentation extract comprises the following steps: crushing walnut green peel and mixing the crushed walnut green peel with a nitrogen fertilizer for compost fermentation to obtain a fermentation product, soaking the fermentation product in water and adjusting a pH to alkaline for reaction, and performing solid-liquid separation after the reaction is completed to obtain solid materials and liquid materials; neutralizing a pH of the liquid materials to acidity, and freeze-drying to obtain a liquid extract; and extracting the solid materials with an organic solvent to obtain a solid extract; and wherein the liquid extract and the solid extract are mixed to obtain the walnut green peel fermentation extract.

2. A seed treatment agent, comprising a diluent of the walnut green peel fermentation extract of claim 1, and a seed disinfectant.

3. A seedling-raising matrix cotton, wherein the walnut green peel fermentation extract of claim 1 is added to the seedling-raising matrix cotton.

4. The seedling-raising matrix cotton according to claim 3, wherein the seedling-raising matrix cotton further comprises a fertilizer.

5. The seedling-raising matrix cotton according to claim 4, wherein the fertilizer is any one or more of large and medium trace element fertilizers, and a weight ratio of the walnut green peel fermentation extract to the fertilizer is 1-2:12-20.

6. The method for preparing the seedling-raising matrix cotton according to claim 3, wherein a surface of the seedling-raising matrix cotton is sprayed with the walnut green peel fermentation extract, NPK, and compound medium trace elements fertilizer and dried to obtain the seedling-raising matrix cotton.

7. A method for raising rice seedlings in a seedling-raising matrix cotton, comprising the following steps: soaking and germinating rice seeds with the seed treatment agent of claim 2, and fully irrigating the seedling-raising matrix cotton of any one of claims 3-5 with water to be sown and covered with soil; and spraying the walnut green peel fermentation extract of claim 1 at an application rate of 800 to 2,000 g per mu when the seedlings are in one leaf and one center.

8. The method for raising rice seedlings in a seedling-raising matrix cotton according to claim 7, wherein when a temperature exceeds 30° C., the rice seedlings and root systems grow too fast, or the seedlings suffer from drought stress, or the seedlings are deficient in fertilizer and bakanae disease occurs, the walnut green peel fermentation extract of claim 1 is mixed with an ammoniacal nitrogen fertilizer to prepare a liquid spray for spraying, and wherein the walnut green peel fermentation extract is applied at an amount of 1,000 to 1,500 g per mu.

9. The method for preparing the seedling-raising matrix cotton according to claim 4, wherein a surface of the seedling-raising matrix cotton is sprayed with the walnut green peel fermentation extract, NPK, and compound medium trace elements fertilizer and dried to obtain the seedling-raising matrix cotton.

10. The method for preparing the seedling-raising matrix cotton according to claim 5, wherein a surface of the seedling-raising matrix cotton is sprayed with the walnut green peel fermentation extract, NPK, and compound medium trace elements fertilizer and dried to obtain the seedling-raising matrix cotton.
